(19) United States
(12) Patent Application Publication
(10) Pub. No.: US 2004/0185975 A1
(43) Pub. Date: Sep. 23, 2004

(54) Chain-poking device for derailleurs

(76) Inventor: Po-Cheng Chen, Taipei (TW)

Correspondence Address: OSTROLENK FABER GERB & SOFFEN, 1180 AVENUE OF THE AMERICAS, NEW YORK, NY, 100368403

(21) Appl. No.: 10/394,310

(22) Filed: Mar. 20, 2003

(51) Int. Cl. F16H 9/00

(52) U.S. Cl. 474/80; 474/82

(57) ABSTRACT

A chain-poking device for derailleurs is comprised of a poking member and a holder. The holder is closely clamped onto a bicycle's frame and the poking member has a stud and a protuberance. The stud is arranged penetrating a slot of the holder and locked with a nut. When the nut is loosened, the relative position of the poking member to the holder could be adjusted for further regulating the chain's position.

### FIELD OF THE INVENTION

This invention relates to a chain-poking device for derailleur. The position of a poking member of the chain-poking device is adjustable to fit a derailleur of a different type so as to poke the chain of the derailleur smoother without any checks.

### BACKGROUND OF THE INVENTION

The speed of a generic derailleur could be changed by mounting a drive chain on a sprocket cluster so that a rider may select a sprocket at a time by shifting the drive chain to change the speed of the derailleur according to a gear ratio.

A conventional chain-poking member is a device fixedly mounted on a bicycle frame of specific design, hence it is inapplicable to another bicycle of different style. This incompatibility could bring about some inconvenience or troubles in manufacture to hence raise the cost accordingly.

### SUMMARY OF THE INVENTION

The primary objective of this invention is to provide an improved chain-poking device for derailleur, in which a poking member could be relatively shifted to a holder for adjusting the position of the poking member according to the type of a derailleur.

In order to realize abovesaid objective, the poking device of this invention should comprise the poking member and the holder, in which the poking member has a stud and a protuberance; and the holder has a slot to allow penetration of the stud and meanwhile reception of the protuberance, such that a nut could be locked on the stud for combining the poking member and the holder together. When the nut is loosened, the relative position of the poking member to the holder may be adjusted.

For more detailed information regarding advantages or features of this invention, at least an example of preferred embodiment will be fully described below with reference to the annexed drawings.

### DESCRIPTION OF THE DRAWINGS

The related drawings in connection with the detailed description of this invention to be made later are described briefly as follows, in which:

FIG. 1 is an exploded three-dimensional view of this invention showing the relative positions of a poking member and a fixing base;

FIG. 2 is a three-dimensional view showing the combined poking member and fixing base;

FIG. 3 is a three-dimensional view showing that a chain-poking device in an embodiment of this invention is assembled on a bicycle frame;

FIG. 4 is a plane view showing that the chain-poking device in an embodiment of this invention is assembled on a bicycle frame;

FIG. 5 is plane view showing that the chain-poking device in an embodiment of this invention can be adjusted on a bicycle frame;

FIG. 6 is a plane action-view showing that the chain-poking device in an embodiment of this invention assembled on a bicycle frame can be swung to the left for adjustment; and

FIG. 7 is a plane action-view showing that the chain-poking device in an embodiment of this invention assembled on a bicycle frame can be swung to the right for adjustment.

### DETAILED DESCRIPTION OF THE INVENTION

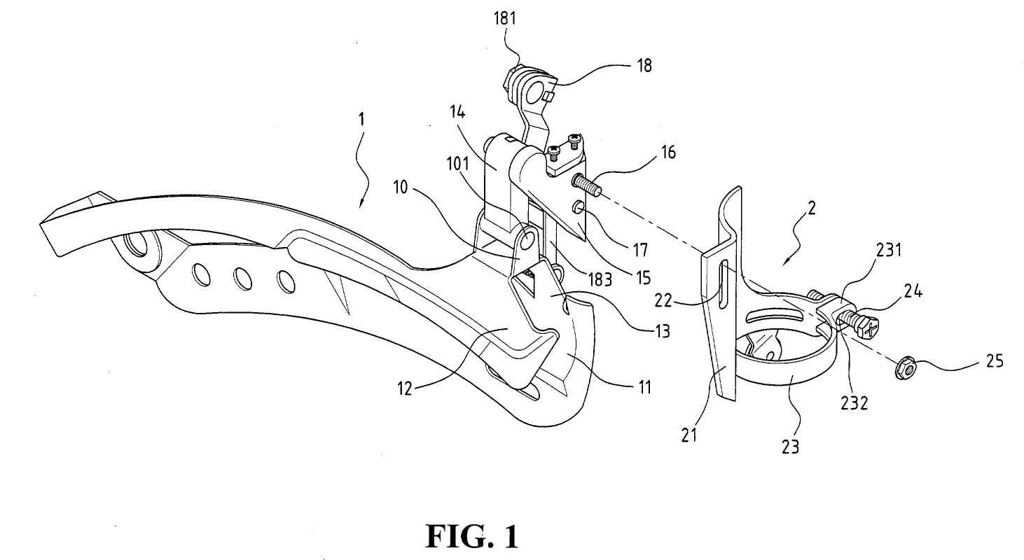

As shown in FIG. 1, according to an embodiment of this invention, a chain-poking device is comprised of a poking member 1 and a holder 2, in which the poking member 1, whose cutaway section is substantially [symbol] -shaped, has an inside and an outside plates 11, 12 having their upper ends connected to each other, in which a space 13 between the plates 11, 12 is formed for a chain (not shown) to pass through. Besides, a projecting member 14 is defined on top of the poking member 1 to have its upper end connected with a base member 15, whose front end is fixedly provided with a stud 16 and a protuberance 17.

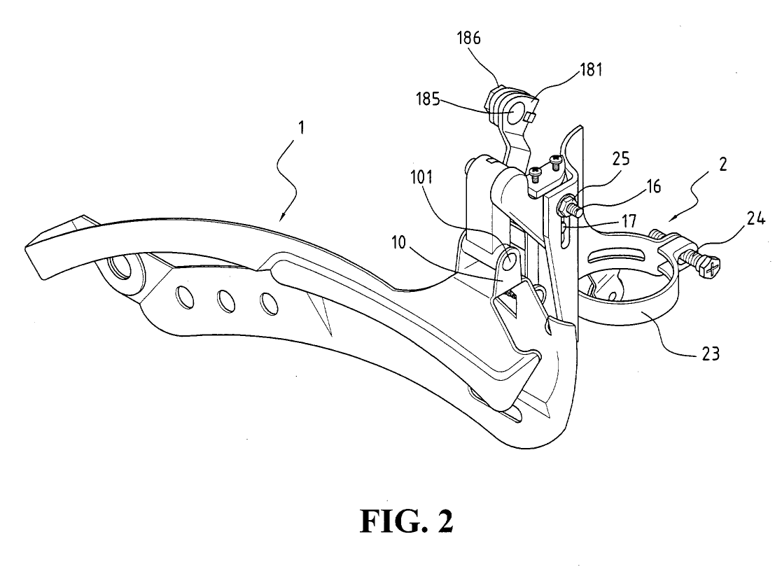

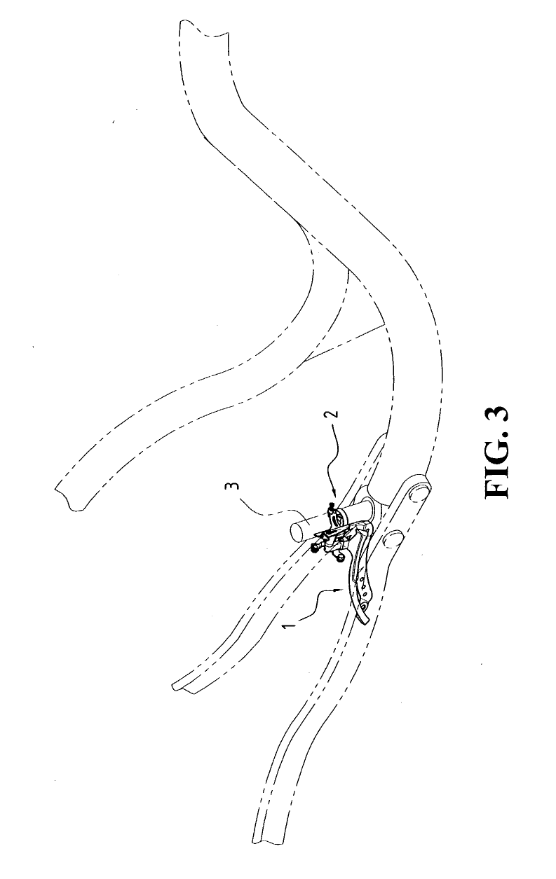

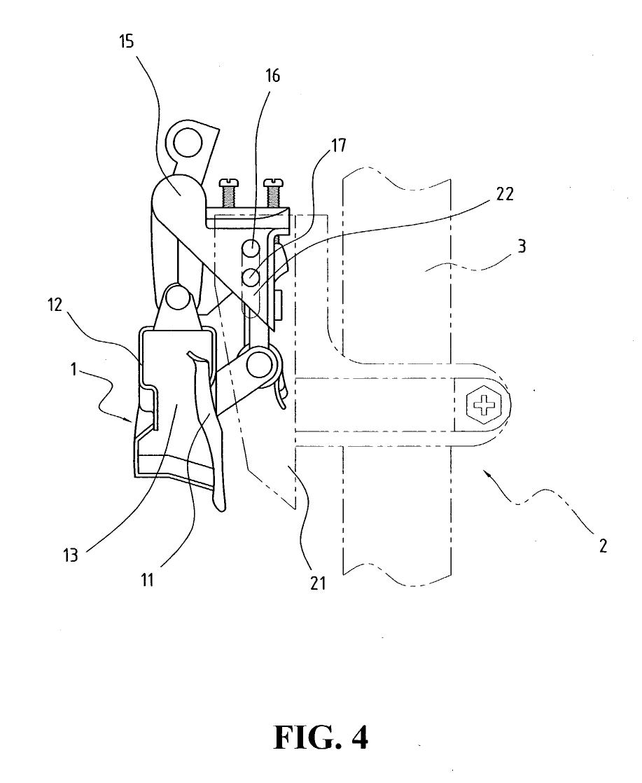

Preferably, the holder 2 is integrally formed to comprise a ferrule 23 and a plate 21. In the plate 21, a vertical slot 22 having a width approximately equal to the diameter of the protuberance 17 is arranged. In the ferrule 23, a gap provided with a projecting ear 231 defined with a through hole 232 on respective sides is reserved, such that a clamping bolt 24 could be inserted to penetrate the through holes 232 of the ears 231 and screw-locked on the clamping bolt 24 with a nut to thereby close the gap of the ferrule 23. When assembling, after the ferrule 23 has been first sleeve-jointed to a bicycle frame at a proper position, a user is supposed to set the clamping bolt 24 duly and lock it with the nut to clamp the holder 2 on the bicycle frame as shown in FIGS. 3 and 4. The stud 16 is applied to penetrate the vertical slot 22 in the holder 2 in such a manner that the protuberance 17 is also received meanwhile in the slot 22, then a nut 25 is screwed on the stud 16 to combine the holder 2 and the poking member 1 together (shown in FIGS. 2 and 4).

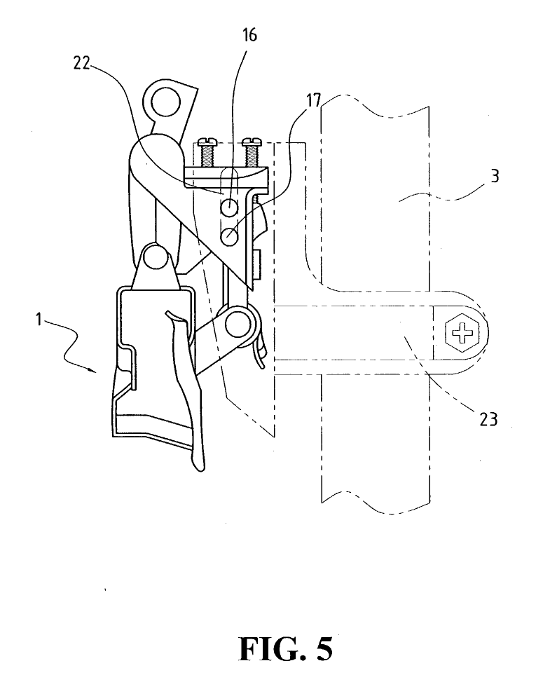

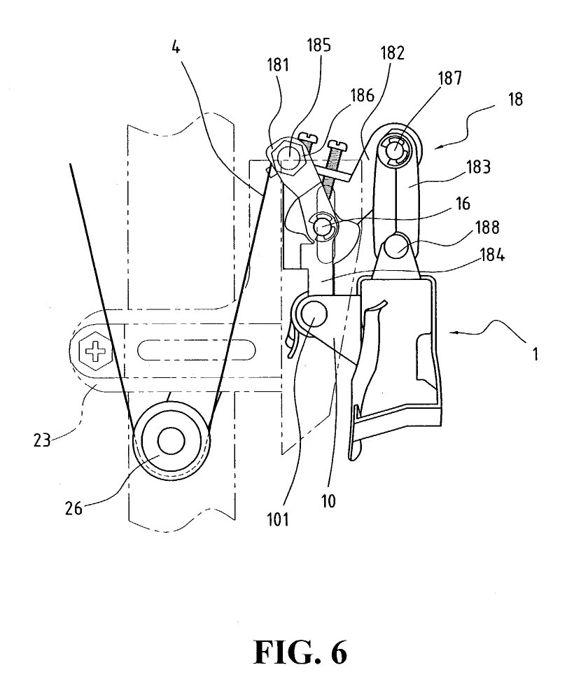

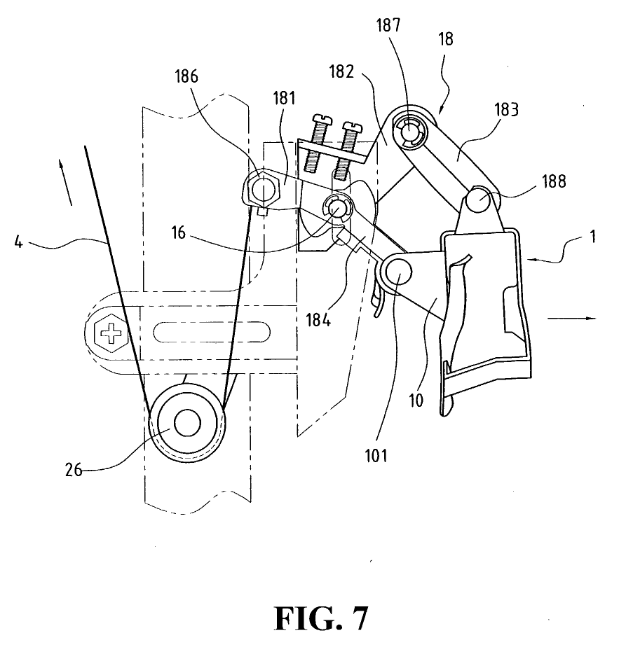

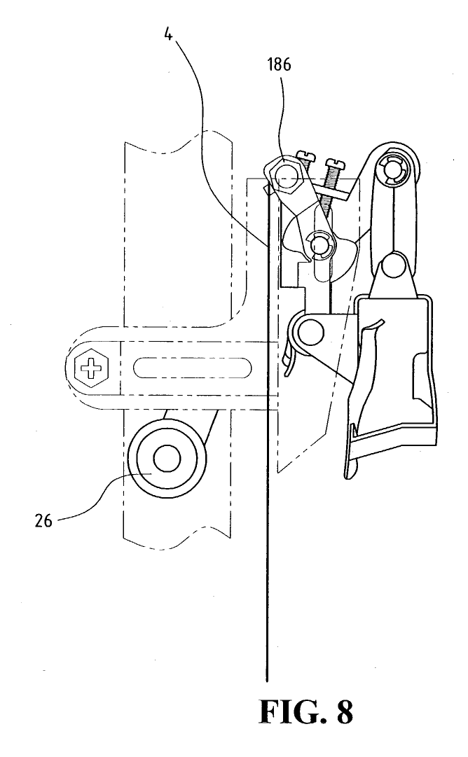

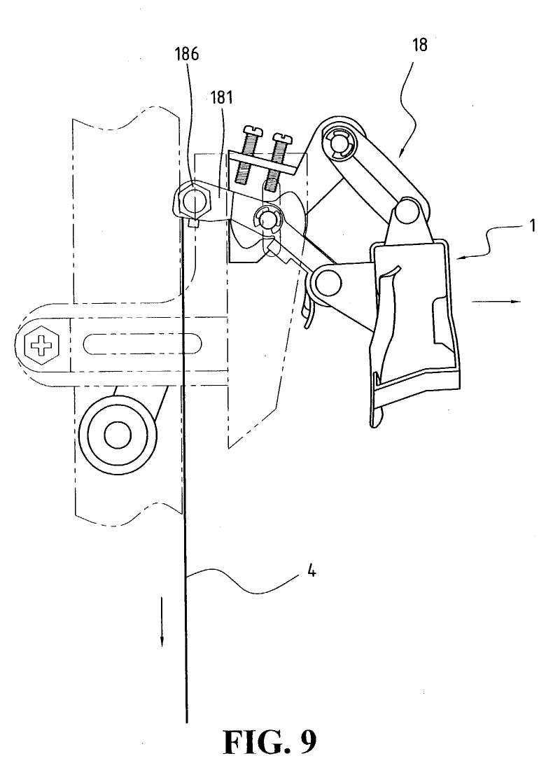

According to the embodiment described, after fixedly assembling the holder 2 on a bicycle frame 3, the poking member 1 is fastened by the nut 25, and when position adjustment is required in response to another different type of derailleur, a user is supposed to loosen the nut 25 first, then shift the poking member up and down to move the stud 16 and the protuberance 17 along the slot 22 as shown in FIG. 5 until an optimum position is reached, finally, screw the nut tightly for fixing the poking member 1 and the holder 2. The purpose of inserting the stud 16 and the protruberance 17 in the slot 22 is to prevent any relative rotation between the poking member 1 and the holder 2 to hence maintain the stability of the poking member 1.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A chain-poking device for derailleurs, comprising:
a poking member combined with a base member having a stud and a protuberance; and
a holder having a ferrule and a plate, in which a vertical slot is formed in said plate while a gap defined in said ferrule has a projecting ear with a through hole at respective ends;
in which said stud could penetrate the slot of said holder for being locked with a nut in a manner that the protuberance is also received meanwhile in said slot, and when the nut is loosened, said poking member and said holder are released and movable relatively; said ferrule could be sleeve-jointed with a bicycle frame and locked thereon by using a bolt to penetrate the through holes in the projecting ears for being fixed to the bicycle frame with a nut.

2. The chain-poking device for derailleurs according to claim 1, in which the diameter of said protuberance is approximately equal to the width of said slot.
